(19) United States
(12) Patent Application Publication
(10) Pub. No.: US 2007/0089924 A1
(43) Pub. Date: Apr. 26, 2007

(54) Apparatus and method for hydraulically converting movement of a vehicle wheel to electricity for charging a vehicle battery

(75) Inventors: Roger A. de la Torre, Wentzville, MO (US); Matthew P. LaConte, Maryland Heights, MO (US); Matthew Allen Adam, Bowling Green, MO (US)

Correspondence Address: THOMPSON COBURN, LLP, ONE US BANK PLAZA, SUITE 3500, ST LOUIS, MO, 63101, US

(73) Assignee: TowerTech Research Group

(21) Appl. No.: 11/481,221

(22) Filed: Jul. 5, 2006

Related U.S. Application Data
(63) Continuation-in-part of application No. 11/257,194, filed on Oct. 24, 2005.

(51) Int. Cl. B60K 17/00

(52) U.S. Cl. 180/305

(57) ABSTRACT

An apparatus and its method of operation hydraulically convert the relative movements between a vehicle wheel and a body of the vehicle to electricity, and use the electricity to recharge a battery of the vehicle. A generator is provided on the vehicle and a hydraulic motor is provided on the vehicle to rotate an input shaft of the generator. A double acting piston and cylinder assembly is operatively connected to each wheel of the vehicle, and each double acting piston and cylinder assembly is connected through a hydraulic circuit to the hydraulic motor. Movements of the vehicle wheels during operation of the vehicle cause reciprocating movements of each piston in each double acting piston and cylinder assembly. The reciprocating movements of the pistons pump liquid to the hydraulic motor and draw liquid from the hydraulic motor to cause operation of the hydraulic motor. The operation of the hydraulic motor drives the generator input shaft, which in turn produces electricity that is supplied to the vehicle battery to recharge the vehicle battery.

This patent application is a continuation-in-part of patent application Ser. No. 11/257,194, filed Oct. 24, 2005, and currently pending.

### BACKGROUND OF THE INVENTION

(1) Field of the Invention

The present invention pertains to an apparatus and a method for hydraulically converting the relative movements between a vehicle wheel and a body of the vehicle to electricity, and using the electricity to recharge a battery of the vehicle. In particular, the present invention pertains to a generator and a hydraulic motor provided on a vehicle, where the hydraulic motor is operatively connected to an input shaft of the generator. A double acting piston and cylinder assembly is operatively connected to each wheel of the vehicle, and each double acting piston and cylinder assembly is connected through a hydraulic circuit to the hydraulic motor. Movements of the vehicle wheels during operation of the vehicle cause reciprocating movements of each piston in each double acting piston and cylinder assembly. The reciprocating movements of the pistons pump liquid to the hydraulic motor and draw liquid from the hydraulic motor, which cause the operation of the hydraulic motor. The operation of the hydraulic motor drives the generator input shaft, which in turn produces electricity that is supplied to the vehicle battery to recharge the vehicle battery.

(2) Description of the Related Art

The increasing costs of fuels used to power internal combustion engine vehicles has led to the development of hybrid vehicles. Hybrid vehicles are powered by both an internal combustion engine and an electric motor. The electric motor is powered by a battery provided on the vehicle. A generator is provided on the vehicle to recharge the battery. The generator is mechanically connected to the internal combustion engine and is electrically connected to the battery. Operation of the internal combustion engine rotates the armature of the generator relative to the stator of the generator, which produces electricity that charges the battery.

During vehicle operation, the internal combustion engine is primarily relied on to power the vehicle in high load situations, such as during acceleration or climbing a hill. A control system of the vehicle automatically switches over to the electric motor during low load operation of the vehicle, for example during cruising at a constant speed. The battery of the vehicle powers the electric motor during this mode of operation.

In the operation of a conventional hybrid vehicle, the output of the internal combustion engine is relied on to rotate the armature of the generator to produce the electricity that recharges the vehicle battery that in turn powers the electric motor of the vehicle. In order to increase the efficiency of the hybrid vehicle, it would be beneficial to convert other mechanical movements of the vehicle to electricity to assist in recharging the vehicle battery.

### SUMMARY OF THE INVENTION

The present invention provides an apparatus and method of hydraulically converting to electricity, the reciprocating movements of the wheels of a vehicle as the vehicle is operated. The electricity is communicated to a battery of the vehicle to recharge the battery. In a hybrid vehicle, the battery is employed in powering the electric motor of the vehicle.

The vehicle that employs the apparatus of the invention includes an internal combustion engine and an electric motor. The engine and motor alternatively drive the vehicle. The electric motor is electrically communicated with a battery on the vehicle that provides power to the motor. A generator is also provided on the vehicle. The generator is electrically communicated with the battery to provide electricity and recharge the battery in response to rotation of an input shaft of the generator.

The apparatus of the invention also employs a plurality of double acting piston and cylinder assemblies. Each double acting piston and cylinder assembly is operatively connected to a wheel of the vehicle. Each piston and cylinder assembly includes a hydraulic cylinder having an interior volume. A piston head is mounted in the cylinder interior volume and separates the interior volume into first and second parts. A piston rod projects from the piston head and the hydraulic cylinder. The piston rod is operatively connected to a shock absorber and/or to a wheel of the vehicle. The connection causes the piston rod and the associated piston head to reciprocate in the interior volume of the hydraulic cylinder in response to movements of the vehicle wheel during operation of the vehicle.

A hydraulic circuit communicates each side of each double acting piston and cylinder assembly with a hydraulic motor mounted on the vehicle. An output shaft of the hydraulic motor is operatively connected to the input shaft of the generator. The hydraulic circuit includes a hydraulic liquid pressure line that communicates each double acting piston and cylinder assembly with the hydraulic motor, and a separate hydraulic liquid vacuum line that communicates each double acting piston and cylinder assembly with the hydraulic motor.

The hydraulic liquid pressure line of each double acting piston and cylinder assembly communicates the first and second parts of the cylinder interior volume with the hydraulic motor. The hydraulic liquid vacuum line of each double acting piston and cylinder assembly also communicates the first and second parts of the cylinder interior volume with the hydraulic motor. When the piston head of each double acting piston and cylinder assembly is reciprocated in the cylinder in response to movement of the vehicle wheel relative to the vehicle body, the piston head pumps hydraulic fluid from one side of a double acting piston and cylinder assembly and draws the hydraulic fluid into the opposite side of the double acting piston and cylinder assembly. The hydraulic fluid pumped from the cylinder is directed by the hydraulic liquid pressure line to the hydraulic motor to rotate the motor, while the opposite side of the double acting piston and cylinder assembly draws liquid through the hydraulic liquid vacuum line from the hydraulic motor to the opposite side of the double acting piston and cylinder assembly.

The rotation of the hydraulic motor causes rotation of the generator input shaft, which in turn produces electricity that recharges the battery of the vehicle for use in operation of the electric motor of the vehicle.

The apparatus of the invention and its method of operation convert the vertically reciprocating movements of each vehicle wheel as the vehicle is operated over an uneven surface to rotation of the generator input shaft that in turn produces electricity that charges the vehicle battery.

### DESCRIPTION OF THE DRAWING FIGURES

Further features of the invention are set forth in the following detailed description of the preferred embodiment of the invention and in the following drawing figures.

FIG. 1 is a schematic representation of the apparatus of the invention operatively connected to a wheel of a vehicle and a battery of the vehicle.

FIG. 2 is a schematic representation of the apparatus of the invention and its method of operating.

FIG. 3 is a schematic representation of the apparatus of the invention and its method of operating.

FIG. 4 is a further schematic representation of the apparatus of the invention and its method of operating.

### DETAILED DESCRIPTION OF THE PREFERRED EMBODIMENT

The apparatus of the invention and its method of use have been designed for a wheeled vehicle. In the preferred embodiment, the wheeled vehicle is a hybrid automobile, meaning that the automobile is powered by both an internal combustion engine and an electric motor. However, the general concept of the invention can be employed in most any type of wheeled vehicle where the wheel is supported from a body of the vehicle by a suspension system that enables the wheel to move relative to the vehicle body in response to the wheel rolling over an uneven surface. Furthermore, it is not necessary that the apparatus of the invention and its method of use be relied on in recharging a battery that is used to power an electric motor of the vehicle. The battery could be a conventional battery used in any conventional vehicle. Because the concept of the invention may be employed with most any type of wheeled vehicle, the vehicle on which the invention is used will not be described in detail or shown in detail in the drawing figures.

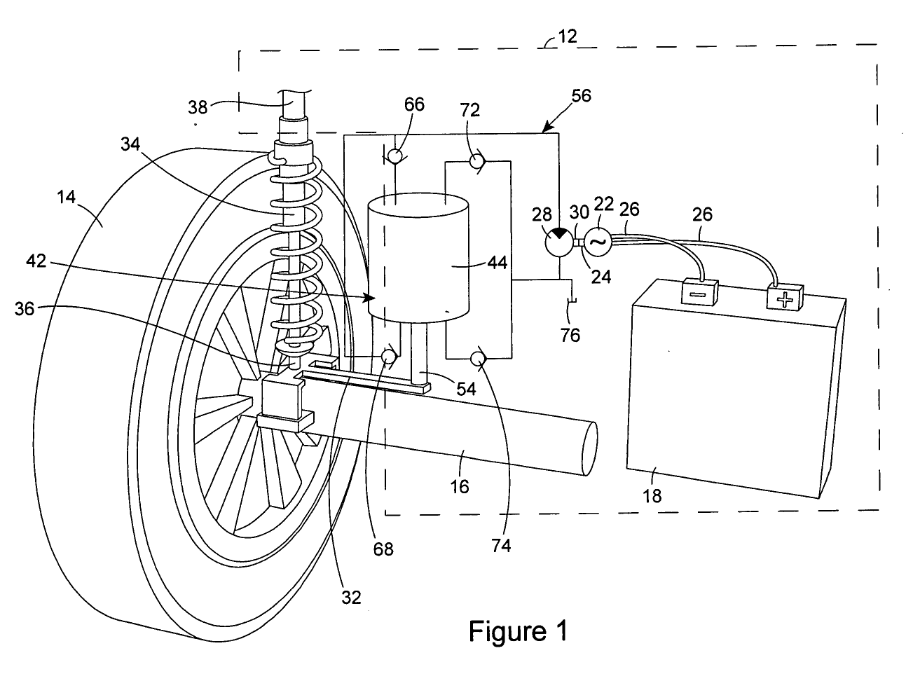

FIG. 1 shows a schematic representation of the apparatus of the invention provided on a wheeled hybrid vehicle. Because the type of vehicle with which the apparatus of the invention is employed is not important for the operation of the apparatus, the body 12 of the vehicle is represented by the dashed lines shown in FIG. 1. The vehicle includes a plurality of wheels 14, each of which is mounted for rotation on an axle 16. The apparatus of the invention is shown with only one wheel of the vehicle in the drawing figures, but it should be understood that the apparatus may be used with each vehicle wheel, and in the preferred embodiment is employed with each vehicle wheel. The wheel 14 and axle 16 are represented schematically in the drawing figures, and are intended to represent the many different types of wheels and axle assemblies employed on vehicles. The vehicle is also provided with a battery 18 that is mounted at a storage location on the vehicle body 12, as is conventional. In the preferred embodiment of the invention, the battery 18 is employed as a power source for an electric motor (not shown) of the hybrid vehicle.

An electric generator 22 is also mounted on the vehicle body 12. The generator 22 has an input shaft 24 that is rotated to operate the generator to convert the mechanical rotation of the shaft to electric energy. The generator 22 may be any known type of generator that could be used on a vehicle to produce electricity used in recharging the battery of the vehicle. The generator 22 is shown electrically communicating with the battery 18 through a pair of electrical conductors 26. The conductors 26 schematically represent any known electrical circuitry between the generator 22 and the battery 18 that would provide the electricity produced by the generator to the battery while regulating the electricity to prevent overcharging of the battery.

A hydraulic motor 28 is also provided on the vehicle body 12. The hydraulic motor 28 may be any type of known hydraulic motor that could be conveniently mounted on a vehicle body 12. The motor 28 has an output shaft 30 that is operatively connected to the electric generator input shaft 24 to rotate the input shaft.

A wheel related support piece 32 is shown schematically in drawing FIG. 1. The wheel related support piece 32 can be any component part of the vehicle that is supported on the vehicle wheel 14. The wheel 14 rotates relative to the wheel related support piece 32 during operation of the vehicle, but the wheel related support piece 32 remains substantially stationary relative to the wheel 14 as the wheel reciprocates along a generally vertical line in response to the wheel rolling over an uneven surface. Thus, the wheel related support piece 32 also moves in generally vertically reciprocating movements in response to the reciprocating movement of the wheel 14 as the wheel rolls over an uneven surface.

A shock absorber 34 is schematically shown in FIG. 1 operatively connected between the wheel related support piece 32 and the vehicle body 12. Any known types of connections between shock absorbers and wheels and vehicle bodies may be employed in attaching the shock absorber 35 to the wheel related support piece 32 and the vehicle body 12. Therefore, the connection between the shock absorber 34 and the vehicle body 12 is not shown in FIG. 1. By being operatively connected to the wheel related support piece 32 and the vehicle body 12, what is meant is that the first end 36 of the shock absorber is either directly connected to the wheel related support piece 32, or is connected to the wheel related support piece 32 through other component parts of the vehicle whereby the shock absorber first end 36 moves with the wheel related support piece 32. The second, opposite end 38 of the shock absorber is operatively connected to the vehicle body 12. Again, by being operatively connected, the shock absorber second end 38 moves with the vehicle body 12.

A double acting piston and cylinder assembly 42 is operatively connected to the shock absorber 34 and the vehicle body 12. Double acting piston and cylinder assemblies are known in the art, and the construction of the assembly 42 employed in the apparatus of the invention can be that of any known double acting piston and cylinder assembly that is capable of operating in the manner to be described. Therefore, the double acting piston and cylinder assembly 42 is shown only schematically in the drawing figures. Basically, the assembly 42 comprises a hydraulic cylinder 44 having an interior volume. A piston head 46 is mounted in the interior bore of the hydraulic cylinder 44 and separates the interior volume into a first part 48 of the interior volume on one side of the piston head 46, and a second part 52 of the interior volume on the opposite side of the piston head 46. A piston rod 54 extends from one side of the piston head 46 and exits the interior volume of the cylinder 44. The piston head 46 is mounted in the cylinder 44 for reciprocating movement, and the piston rod 54 exits the cylinder 44 and reciprocates relative to the cylinder 44, as is conventional. The cylinder 44 is operatively connected to the vehicle body 12 to remain stationary relative to the vehicle body during operation of the vehicle. The piston rod 54 is operatively connected to the shock absorber first end 36, and in the drawing figures is shown operatively connected to the wheel related support piece 32. Thus, the piston rod 54 and the connected piston head 46 are stationary relative to the vehicle wheel 14 and reciprocate in the cylinder 44 in response to movements of the wheel 14 relative to the vehicle body 12.

A hydraulic circuit 56 communicates the double acting piston and cylinder assembly 42 with the hydraulic motor 28. The hydraulic circuit 56 is constructed of known component parts, and is shown schematically in the drawing figures. The hydraulic circuit 56 is basically comprised of a hydraulic liquid pressure line 62 and a hydraulic liquid vacuum line 64 that are separated from each other and do not communicate with each other except through the hydraulic motor 28 and the double acting piston and cylinder assembly 42, as will be explained.

As shown schematically in the drawing figures, the hydraulic liquid pressure line 62 communicates a liquid input port (not shown) of the hydraulic motor 28 with the first part of the cylinder interior volume 48 and the second part of the cylinder interior volume 52. A first check valve or one-way valve 66 is provided between the hydraulic liquid pressure line 62 and the first part of the cylinder interior volume 48. This first check valve 66 allows the flow of liquid from the first part of the cylinder interior volume 48 through the hydraulic liquid pressure line 62 to the hydraulic motor 28, but prevents the reverse flow of fluid from the hydraulic motor 28 to the first part of the cylinder interior volume 48. A second one-way or check valve 68 is positioned in the hydraulic liquid pressure line 62 between the hydraulic motor 28 and the second part of the cylinder interior volume 52. This second check valve 68 allows the flow of hydraulic liquid from the second part of the cylinder interior volume 48 through the hydraulic liquid pressure line 62 to the hydraulic motor 28, but prevents the reverse flow of liquid from the hydraulic motor 28 to the second part of the cylinder interior volume 52.

The hydraulic liquid vacuum line 64 functions to draw hydraulic fluid from the hydraulic motor 28 to the double acting piston and cylinder assembly 42. The liquid vacuum line communicates a liquid output port (not shown) of the hydraulic motor 28 with the first part of the cylinder interior volume 48 and the second part of the cylinder interior volume 52. A third one-way or check valve 72 is provided in the hydraulic liquid vacuum line 64 between the first part of the cylinder interior volume 48 and the hydraulic motor 28. The third check valve 72 functions to allow a flow of hydraulic liquid through the vacuum line 64 from the hydraulic motor 28 to the first part of the cylinder interior volume 48, but prevents the reverse flow of hydraulic fluid from the first part of the cylinder interior volume 48 to the hydraulic motor 28. A fourth one-way or check valve 74 is also provided in the hydraulic liquid vacuum line 62. The fourth check valve 74 is positioned between the second part of the cylinder interior volume 52 and the hydraulic motor 28. This fourth check valve 74 functions to allow a flow of hydraulic liquid through the vacuum line 64 from the hydraulic motor 28 to the second part of the cylinder interior volume 52, but prevents a reverse flow of liquid from the second part of the cylinder interior volume 52 to the hydraulic motor 28. A hydraulic fluid reservoir 74 is also provided as part of the hydraulic liquid vacuum line 64.

The apparatus of the invention is explained above and shown in the drawing figures operatively connected with only one wheel 14 of a vehicle. In the preferred embodiment of the invention, the battery 18, electric generator 22, and hydraulic motor 28 are provided on the vehicle body. Each wheel 14 of the vehicle is provided with a double acting piston and cylinder assembly 42, and a hydraulic liquid pressure line 62 and hydraulic liquid vacuum line 64 that communicate the double acting piston and cylinder assembly 42 with the hydraulic motor 28. Thus, in a four-wheeled vehicle, four separate hydraulic circuits 56 communicate four separate double acting piston and cylinder assemblies 42 associated with the four wheels 14 of a vehicle to a single hydraulic motor 28 mounted on the vehicle.

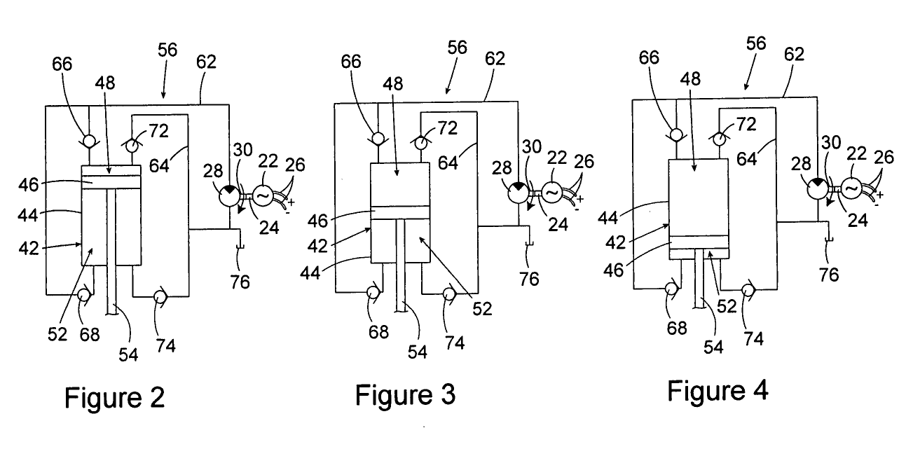

FIGS. 2-4 are schematic representations of the method of operating the apparatus of the invention shown in FIG. 1. As the vehicle 12 is operated and the vehicle wheels 14 travel over an uneven surface, the wheels 14 will move relative to the vehicle body 12. The movement of the wheels 14 will cause generally reciprocating movements of the shock absorbers 34 relative to the vehicle body 12. These reciprocating movements are transmitted to the piston rod 54 of each double acting piston and cylinder assembly 42 associated with each wheel 14 of the vehicle. The reciprocating movements of the piston rod 54 are transferred to the piston head 46 contained in the cylinder 44 of the double acting piston and cylinder assembly 42.

FIG. 2 represents the situation where the movement of the vehicle wheel 14 will cause the piston head 46 to move upwardly in the interior of the cylinder 44 as represented in the drawing figure. As the piston head 46 moves upwardly through the interior of the cylinder 44, the volume of the first part of the cylinder interior volume 48 decreases, forcing liquid from the first part of the cylinder interior volume 48 past the first one-way check valve 66 and into the hydraulic liquid pressure line 62. The second one-way check valve 68 prevents the hydraulic liquid from flowing from the hydraulic liquid pressure line 62 into the second part of the cylinder interior volume 52. The third check valve 72 prevents the liquid forced from the first part of the cylinder interior volume 48 from entering the hydraulic liquid vacuum line 64. The hydraulic liquid forced from the first part of the cylinder interior volume 48 flows through the hydraulic liquid pressure line 62 to the hydraulic motor 28 and operates the motor.

Simultaneously, the movement of the piston head 46 upwardly in the interior volume of the cylinder 44 increases the volume in the second part of the cylinder interior volume 52. This creates a vacuum in the second part of the cylinder interior volume 52 that draws hydraulic liquid from the hydraulic liquid vacuum line 64 and from the hydraulic motor 28. The liquid is drawn from the hydraulic liquid vacuum line 64 past the fourth check valve 74. The connection of the hydraulic liquid vacuum line 64 with the hydraulic liquid reservoir 76 prevents any cavitation from occurring in the line. The second check valve 68 in the hydraulic liquid pressure line 62 prevents any liquid from being drawn from the hydraulic liquid pressure line 62 into the second part of the cylinder interior volume 52 by the vacuum created. The third check valve 72 prevents any liquid from being drawn from the first part of the cylinder interior volume 48.

FIGS. 3 and 4 show the subsequent steps in the operation of the apparatus of the invention where the piston head 46 has moved to its top position in the cylinder 44 shown in FIG. 2, and the reciprocating movement of the piston head 46 back downward through the cylinder 44 is occurring. As the piston head 46 moves downwardly through the cylinder 44 as shown in FIGS. 3 and 4, the hydraulic liquid previously drawn into the second part of the cylinder interior volume 52 is pressurized and forced from the cylinder 44. The fourth check valve 74 prevents the hydraulic liquid forced from the second part of the cylinder interior volume 52 from entering the hydraulic liquid vacuum line 64. The second check valve 68 allows the hydraulic liquid in the second part of the cylinder interior volume 52 to pass through the hydraulic liquid pressure line 62 to the hydraulic motor 28. The first check valve 66 prevents any of the hydraulic liquid forced from the second part of the cylinder interior volume 52 from entering the first part of the cylinder interior volume 48. The liquid from the second part of the cylinder interior volume 52 flows through the hydraulic liquid pressure line 62 through the hydraulic motor 28 and operates the motor.

Simultaneously, as the piston head 46 moves downwardly as represented in FIGS. 3 and 4, a vacuum is created in the first part of the cylinder interior volume 48. The vacuum draws liquid through the hydraulic liquid vacuum line 64 from the hydraulic motor 28 past the third check valve 72 and into the first part of the cylinder interior volume 48. The first check valve 66 prevents the vacuum in the first part of the cylinder interior volume 48 from drawing any hydraulic liquid from the hydraulic liquid pressure line 62. The fourth check valve 74 prevents the vacuum in the first part of the cylinder interior volume 48 from drawing any liquid from the second part of the cylinder interior volume 52.

In the manner discussed above, the reciprocating movements of the piston head 46 in the cylinder 44 caused by movements of the wheel 14 relative to the vehicle body 12 continuously pump hydraulic liquid from one side of the double acting piston and cylinder assembly 42 to the hydraulic motor 28 to operate the motor, while drawing liquid back into the opposite side of the double acting piston and cylinder assembly 42. The operation of the hydraulic motor 28 causes the input shaft 24 of the electric generator 22 to rotate, causing the generator to produce electricity. The electricity is transmitted through the conductors 26 to the battery 18, recharging the battery.

Although the apparatus of the invention and its method of operation have been described above by reference to a specific embodiment, it should be understood that modifications and variations could be made to the apparatus and its method of operation without departing from the intended scope of the following claims.

1) An apparatus for converting movements of a wheel of a vehicle relative to a body of the vehicle to electricity for charging a battery of the vehicle, the apparatus comprising:
a generator mounted on the vehicle, the generator having an input shaft that is rotated to produce electricity from the generator;
a battery mounted on the vehicle, the battery being connected in electrical communication with the generator for receiving electricity produced by the generator;
a hydraulic motor mounted on the vehicle, the hydraulic motor having an output shaft that is operatively connected to the generator input shaft to rotate the generator input shaft on operation of the hydraulic motor;
a piston operatively connected to the wheel of the vehicle for movement of the piston in response to movement of the wheel;
a cylinder mounted on the vehicle, the cylinder receiving the piston for reciprocating movement of the piston in the cylinder in response to movement of the wheel; and,
a hydraulic circuit communicating the cylinder with the hydraulic motor to cause operation of the hydraulic motor in response to movement of the piston in the cylinder.

2) The apparatus of claim 1, further comprising:
a shock absorber operatively connected between the wheel and the vehicle body; and,
the piston being operatively connected to one end of the shock absorber.

3) The apparatus of claim 1, further comprising:
the piston being stationary relative to the wheel during movement of the wheel; and,
the piston being stationary relative to the vehicle body during movement of the vehicle body.

4) The apparatus of claim 1, further comprising:
the piston being operatively connected to the wheel for reciprocating movement of the piston relative to the vehicle body in response to movement of the wheel relative to the vehicle body; and,
the generator, the battery, the hydraulic motor, the cylinder, and the hydraulic circuit all being mounted stationary to the vehicle body.

5) The apparatus of claim 4, further comprising:
the piston being operatively connected to the wheel for vertically reciprocating movement of the piston in response to movement of the wheel relative to the vehicle body.

6) The apparatus of claim 1, further comprising:
the cylinder having an interior volume;
the piston having a piston head in the cylinder interior volume separating the piston interior volume into two parts; and,
the hydraulic circuit communicating with the two parts of the cylinder interior volume.

7) The apparatus of claim 1, further comprising:
the piston being one of a plurality of pistons with each piston of the plurality of pistons being operatively connected to a wheel of the vehicle for movement of each piston in response to movement of the operatively connected wheel of each piston;
the cylinder being one of a plurality of cylinders mounted on the vehicle with each cylinder of the plurality of cylinders receiving a piston of the plurality of pistons for reciprocating movement of the piston in each cylinder; and,
the hydraulic circuit communicating the plurality of cylinders with the hydraulic motor.

8) The apparatus of claim 7, further comprising:
each cylinder of the plurality of cylinders having an interior volume;
each piston of the plurality of pistons having a head in an interior volume of each cylinder separating the cylinder interior volume into two parts; and,
the hydraulic circuit communicating the two parts of each cylinder interior volume with the hydraulic motor.

9) An apparatus for converting movements of a wheel of a vehicle relative to a body of the vehicle to electricity for charging a battery of the vehicle, the apparatus comprising:
a generator mounted on the vehicle, the generator having an input shaft that is rotated to produce electricity from the generator;
a battery mounted on the vehicle, the battery being connected in electrical communication with the generator for receiving electricity produced by the generator;
a hydraulic motor mounted on the vehicle, the hydraulic motor having an output shaft that is operatively connected to the generator input shaft to rotate the generator input shaft on operation of the hydraulic motor;
a cylinder mounted on the vehicle body, the cylinder having an interior volume;
a piston operatively connected to the wheel of the vehicle for movement of the piston in response to movement of the wheel relative to the vehicle body;
the piston having a piston head mounted in the cylinder interior volume dividing the cylinder interior volume into first and second parts; and,
a hydraulic circuit communicating the cylinder with the hydraulic motor, the hydraulic circuit including a pressure line that directs liquid from the cylinder to the hydraulic motor, and a liquid vacuum line that directs liquid from the motor to the cylinder.

10) The apparatus of claim 9, further comprising:
the hydraulic circuit pressure line being separate from the hydraulic circuit vacuum line.

11) The apparatus of claim 9, further comprising:
the hydraulic circuit pressure line communicating both the first and second parts of the cylinder interior volume with the hydraulic motor, and the hydraulic circuit vacuum line communicating the hydraulic motor with both the first and second parts of the cylinder interior volume.

12) The apparatus of claim 9, further comprising:
a shock absorber operatively connected between the wheel and the body; and,
the piston being operatively connected to one end of the shock absorber.

13) The apparatus of claim 9, further comprising:
the piston being stationary relative to the wheel during movement of the wheel; and,
the cylinder being stationary relative to the vehicle body during movement of the wheel.

14) The apparatus of claim 9, further comprising:
the piston being operatively connected to the wheel for reciprocating movement of the piston relative to the vehicle body in response to movement of the wheel relative to the vehicle body; and,
the generator, the battery, the hydraulic motor, the cylinder, and the hydraulic circuit all being mounted stationary to the vehicle body.

15) The apparatus of claim 9, further comprising:
the piston being one of a plurality of pistons with each piston of the plurality of pistons being operatively connected to a wheel of the vehicle for movement of each piston in response to movement of the operatively connected wheel of each piston;
the cylinder being one of a plurality of cylinders mounted on the vehicle with each cylinder of the plurality of cylinders receiving a piston of the plurality of pistons for reciprocating movement of the piston in each cylinder; and,
the hydraulic circuit communicating the plurality of cylinders with the hydraulic motor.

16) The apparatus of claim 9, further comprising:
at least one pressure check valve provided in the hydraulic circuit pressure line to control a flow of hydraulic liquid from the cylinder to the hydraulic motor and prevent a reverse flow of hydraulic liquid from the hydraulic motor to the cylinder; and,
at least one vacuum check valve provided in the hydraulic circuit vacuum line to control a flow of hydraulic liquid from the hydraulic motor to the cylinder and prevents a reverse flow of hydraulic liquid from the cylinder to the hydraulic motor.

17) The apparatus of claim 9, further comprising:
first and second check valves provided in the hydraulic circuit between the respective cylinder interior volume first part and the hydraulic motor and the cylinder interior volume second part and the hydraulic motor, the first and second check valves controlling a flow of hydraulic liquid from the cylinder to the hydraulic motor and preventing a reverse flow of hydraulic liquid from the motor to the cylinder; and,
third and fourth check valves provided in the hydraulic circuit between the respective cylinder interior volume first part and the hydraulic motor and the cylinder interior volume second part and the hydraulic motor, the third and fourth check valves controlling a flow of hydraulic liquid from the hydraulic motor to the cylinder and preventing a reverse flow of hydraulic liquid from the cylinder to the hydraulic motor.

18) A method of converting movements of a wheel of a vehicle relative to a body of the vehicle to electricity and charging a battery of the vehicle, the method comprising:
providing a generator on the vehicle with the generator having an input shaft that is rotated to produce electricity from the generator;
connecting the generator in electrical communication with the battery to supply the electricity produced by the generator to the battery;
providing a hydraulic motor with an output shaft on the vehicle and operatively connecting the hydraulic motor output shaft to the generator input shaft to rotate the input shaft in response to operation of the hydraulic motor;
providing a piston and operatively connecting the piston to the wheel of the vehicle for movement of the piston in response to movements of the wheel;
providing a cylinder on the vehicle and mounting the piston in the cylinder from reciprocating movement of the piston in the cylinder in response to movement of the wheel; and,
communicating the cylinder with the hydraulic motor by a hydraulic circuit that causes operation of the hydraulic motor in response to movement of the piston in the cylinder.

19) The method of claim 18, further comprising:
providing the piston and cylinder as a double acting piston and cylinder assembly and communicating opposite sides of the double acting piston and cylinder assembly with the hydraulic circuit.

20) The method of claim 18, further comprising:
providing a plurality of pistons and operatively connecting each piston of the plurality of pistons to a wheel of the vehicle for movement of the piston in response to movement of the wheel;
providing a plurality of cylinders and mounting a piston of the plurality of pistons in each cylinder for reciprocating movement of each piston in each cylinder; and
communicating the plurality of cylinders with the hydraulic motor by the hydraulic circuit.
